(19) United States
(12) Patent Application Publication
(10) Pub. No.: US 2026/0333222 A1
(43) Pub. Date: Oct. 22, 2026

(54) METHOD AND APPARATUS FOR HANDLING OF WAKE UP SIGNALING AND CSI REPORTING IN WIRELESS NETWORKS

(71) Applicant: Samsung Electronics Co., Ltd., Suwon-si, Gyeonggi-do (KR)

(72) Inventors: Vinay Kumar SHRIVASTAVA, Bangalore (IN); Aby Kanneath ABRAHAM, Bangalore (IN); Sriganesh RAJENDRAN, Bangalore (IN)

(21) Appl. No.: 19/099,586

(22) PCT Filed: Aug. 8, 2023
(86) PCT No.: PCT/KR2023/011679

§ 371 Date: Jan. 29, 2025

(30) Foreign Application Priority Data
Aug. 10, 2022 (IN) 202241045749
Jul. 21, 2023 (IN) 2022 41045749

(51) Int. Cl. H04W 52/02; H04B 7/06; H04W 76/27; H04W 76/28

(52) U.S. Cl. CPC H04W 52/0235; H04B 7/0626; H04W 76/27; H04W 76/28

(57) ABSTRACT

The disclosure relates to a 5G or 6G communication system for supporting a higher data transmission rate. Embodiments herein provide a method and system for wake-up signaling mechanism and Channel State Information (CSI) reporting operation for Extended Reality (XR) in wireless networks. The method includes configuring, by a network apparatus, an unicast DCP (DCI for power saving) and a XR wakeup signal at a user equipment (UE); determining, by the network apparatus, the unicast DCP and the XR wakeup signal are configured at the UE; transmitting, by the network apparatus, one or more offset values to apply to the UE for starting the DRX On duration Timer for XR services; and adjusting, by the UE, offset value to delay or to start in advance of a DRX On Duration Timer at the UE for XR services in the wireless networks.

### TECHNICAL FIELD

The present disclosure relates to a wireless communication, and more specifically related to wake-up signaling and Channel State Information (CSI) reporting for Extended Reality in wireless networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

An Extended Reality (XR) is an umbrella term for different realities including Virtual Reality (VR), Augmented Reality (AR) and Mixed Reality (MR), and is considered as an essential technology to enable the realization of digital twin/meta universe. The XR is incorporated as an agreed work item in 5G Advanced (i.e. 3GPP Release 18), which is targeted to provide a communication system framework that fulfills challenging needs of high data rate, very low latency and power efficient connectivity for the XR applications. Particularly the power saving mechanism including wake-up signaling and a Channel State Information (CSI) reporting mechanism may need to be enhanced and adopted for XR specific Discontinuous reception (DRX) operations.

### DISCLOSURE OF INVENTION

### Solution to Problem

The principal object of the embodiments herein is to provide a method and system of handling of wake-up signaling and Channel State Information (CSI) reporting mechanisms for Extended Reality (XR) in wireless networks.

Accordingly, the embodiments herein provide a method and system for handling of wake-up signaling and CSI Reporting for Extended Reality (XR) services in wireless networks.

In an embodiment, a method for handling of wake up signaling for Extended Reality (XR) services in a wireless network, includes configuring a unicast DCP (DCI for power saving) and a XR wakeup signal at a user equipment (UE). The method determining the unicast DCP and the XR wakeup signal are configured at the UE. The method includes transmitting offset values to apply to the UE for starting the drx-on duration timer for XR services. The method includes adjusting the offset value to delay or to start in advance of a drx-on duration timer at the UE for XR services in the wireless networks.

In an embodiment, the method includes determining a DCP occasion in a time domain is associated with a DRX cycle. The method includes transmitting a DCP indication to the UE. The method includes determining DRX active time of the UE considering active time conditions from the DCP indication. The method includes monitoring the DCP indication received from the network apparatus based on the unicast DCP and the XR wakeup signal configured at the UE. The method includes determining the unicast DCP configured to carry the XR start offset received from the network apparatus. The method includes activating the drx-on duration timer after adding the drx-SlotOffset and the drx SlotOffsetXR from beginning of a subframe.

In an embodiment, the method includes determining the DCP occasion in the time domain associated with the DRX cycle occurred in the active time. The method includes monitoring the DCP indication received for the DRX cycle from the network apparatus. The method includes determining the drxStartOffsetXR and the drxSlotOffsetXR in the DCI carrying indication of the wakeup signal receiving from the network apparatus. The method includes activating the drx-on duration timer for the DRX cycle after adding the drx-SlotOffset from beginning of the subframe. The beginning of the subframe is determined by considering the drxStartOffsetXR. The active time conditions includes grants, assignments, DRX Command MAC CE, Long DRX Command MAC CE received, Dynamic start offset received from the DCP, Scheduling Request sent until four milliseconds prior to start of the DCP occasion, or during a measurement gap, or when a MAC entity monitors for a PDCCH transmission on a search space indicated by recoverySearchSpaceId of a SpCell identified by a C-RNTI while a ra-Response Window is running.

In an embodiment, the method includes configuring the XR wakeup signal at the user equipment (UE). The method includes determining the XR wakeup signal is configured at the UE. The method includes determining XR WUS occasion in a time domain is associated with a DRX cycle. The method includes transmitting a XR WUS indication to the UE. The method includes determining DRX active time of the UE considering the active time conditions. The method includes monitoring the XR WUS occasions outside of the determined DRX active time. The method includes receiving the XR WUS indication received from the network apparatus based on the XR wakeup signal configured at the UE. The method includes determining the XR wakeup signal received with start offset from the network apparatus. The method includes activating the drx-on duration timer after adding the drx-SlotOffset and the drx SlotOffsetXR from beginning of a subframe.

In an embodiment, the method for configuring the XR wakeup signal at the user equipment (UE) includes configuring a XR specific DRX configuration at the UE. The method includes determining the XR wakeup signal is configured at the UE. The method includes determining active time of the UE considering the one or more active time conditions. The method includes determining XR WUS occasion in a time domain is associated with a DRX cycle occurred in the active time. The method includes transmitting a XR WUS indication to the UE. The method includes monitoring the XR WUS indication received from the network apparatus based on the XR wakeup signal configured at the UE. The method includes determining the XR wakeup signal received with start offset from the network apparatus. The method includes activating a XR specific drx-on duration timer, drx-onDurationTimerXR, after adding drx-SlotOffset and the drx SlotOffsetXR from beginning of a subframe.

In an embodiment, the method includes configuring a validity timer value for DRX start offset at the user equipment (UE). The method includes determining the validity timer value for DRX start offset is configured at the UE. The method includes transmitting DRX start offset value or indication to apply stored DRX offset value to the UE. The method includes activating the offset validity timer upon receiving the DRX start offset value or indication to apply stored DRX offset value from the network apparatus as part of DCI carrying a wake up indication. The method includes activating a XR specific DRX On duration Timer, drx-onDurationTimerXR after adding the drx-SlotOffset and the drx SlotOffsetXR from beginning of a subframe. The method includes deactivating the application of offset value upon expiry of the offset validity timer at the UE.

In an embodiment, the method for controlling transmission of a Channel State Information (CSI) by a User Equipment (UE) includes receiving an allowCSI-SRS-Tx-XR-DRX-Active parameter in a RRC reconfiguration message from a network apparatus. The method includes determining the configured allowCSI-SRS-Tx-XR-DRX-Active parameter allows the UE to transmit the SRS and report the CSI during a XR Discontinuous Reception (DRX). The method includes determining a time for transmitting the SRS and reporting the CSI during the XR service reception based on the allowCSI-SRS-Tx-XR-DRX-Active parameter when the allowCSI-SRS-Tx-XR-DRX-Active parameter allows the UE to transmit the SRS and report the CSI during the XR DRX. The method includes transmitting the SRS and reporting the CSI in the determined time based on an active time of the unicast DRX and the XR DRX.

In an embodiment, a UE for handling of wake up signaling for Extended Reality (XR) services in a wireless network. The UE includes a unicast and XR DRX configuration, a drx on-Duration Timer, a Unicast and XR Wake up signaling configuration, a CSI reporting controller, communicatively coupled to a memory and a processor, may configure an unicast DCP (DCI for power saving) and a XR wakeup signal at the UE; determine the unicast DCP and the XR wakeup signal are configured at the UE; transmit offset values to apply to the UE for starting the DRX On duration Timer for XR services; adjust offset value to delay or to start in advance of a DRX On Duration Timer at the UE (401) for XR services in the wireless networks.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates DRX operation at UE when the network signals the XR specific start offset through DCP signaling and a common DRX configuration is used for unicast services or non-XR services and XR services, according to the embodiments of the present disclosure;

FIG. 2 illustrates DRX operation at UE when the network signals the XR specific start offset through XR specific DCP signalling and a common DRX configuration is used for legacy unicast services or non-XR services and XR services, according to the embodiments of the present disclosure;

FIG. 3 illustrates DRX operation at UE when the network signals the XR specific start offset through XR specific DCP signaling and separate DRX configuration is used for XR services, according to the embodiments of the present disclosure; and

FIG. 4 illustrates hardware features of the UE for handling wake up signaling and CSI reporting for extended reality services in wireless networks, according to the embodiments of the present disclosure.

FIG. 5 illustrates a structure of a UE according to an embodiment of the disclosure.

FIG. 6 illustrates a structure of a network entity (or network apparatus) according to an embodiment of the disclosure.

### BEST MODE FOR CARRYING OUT THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide a method and system for wake-up signaling mechanism and Channel State Information (CSI) reporting operation for Extended Reality (XR) in wireless networks.

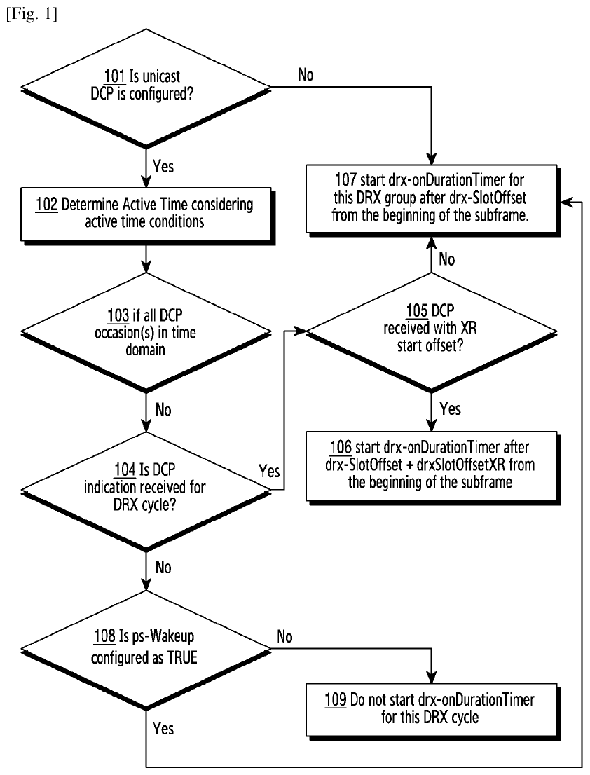

FIG. 1 is a flow chart illustrating a method for handling of wake up signaling for Extended Reality (XR) services in a wireless network, according to the embodiments as disclosed herein.

Referring to FIG. 1 illustrates DRX operation at UE when the network signals the XR specific start offset through DCP signaling and a common DRX configuration is used for unicast services or non-XR services and XR services, according to the embodiments of the present disclosure.

At step 101, the method includes configuring, by a network apparatus, an unicast DCP (Downlink Control Information for Power Saving) and a XR wakeup signal at a user equipment (UE) determining whether the unicast DCP and the XR wakeup signal are configured at the UE;

At step 102, the method includes determine active time considering grants/assignments/DRX Command MAC CE/Long DRX Command MAC CE received, Dynamic start offset received from DCP, Scheduling Request sent until 4 milliseconds prior to start of the last DCP occasion, or during a measurement gap, or when the MAC entity monitors for a PDCCH transmission on the search space indicated by recoverySearchSpaceId of the SpCell identified by the C-RNTI while the ra-Response Window is running.

At step 103, the method includes determining, by the network apparatus, a DCP occasion in a time domain is associated with a DRX cycle; if all DCP occasion(s) in time domain, associated with the current DRX cycle occurred in active time as determined.

At step 104, the method includes monitoring, by the UE, whether the DCP indication received for the DRX cycle from the network apparatus; Monitor DCP based on configuration. Is DCP indication received for this DRX cycle?; determining whether the drxStartOffsetXR and the drx-SlotOffsetXR in the DCI carrying indication of the wakeup signal receiving from the network apparatus;

If the answer at step 104 is Yes, the method continues At step 105, the method includes determining whether the DCP received with XR start offset?; Unicast DCP configured to carry XR start offset.

If the answer at step 105 is Yes, the method continues At step 106, the method includes activating, by the UE, the drx-on duration timer for the DRX cycle after adding the drx-SlotOffset and the drx-SlotOffsetXR from beginning of a subframe.

At step 101 and 105, is No, the method continues at step 107, the method includes start drx-onDurationTimer for this DRX group after drx-SlotOffset from the beginning of the subframe.

If the answer at step 104 is No, the method continues at step 108, the method includes determining whether the ps-Wakeup configured as TRUE

If the answer at step 108 is Yes, the method continues at step 107, the method includes activating, drx-onDurationTimer for this DRX group after adding the drx-SlotOffset from the beginning of the subframe.

If the answer at step 108 is No, the method continues at step 109, the method includes Do not start drx-onDurationTimer for this DRX cycle.

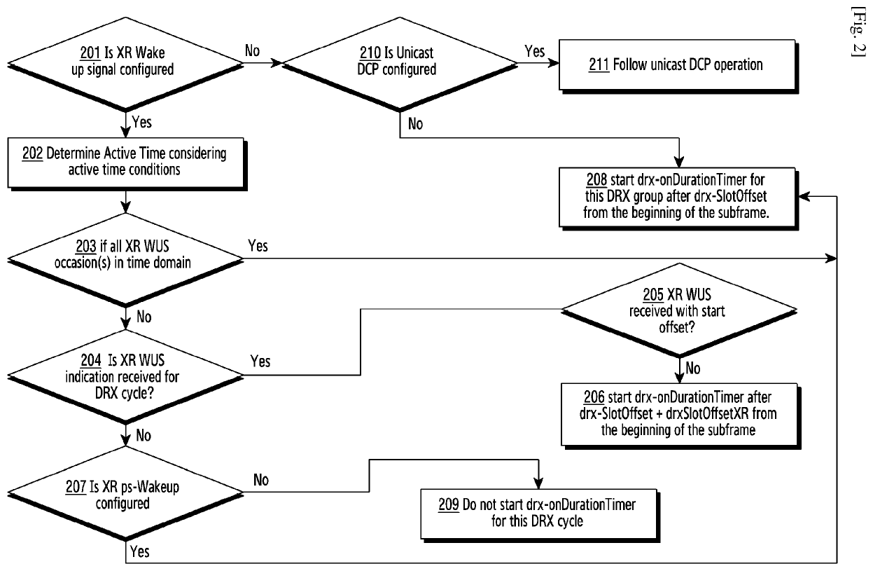

FIG. 2 is an another example flow chart illustrating a method for handling of wake up signaling for Extended Reality (XR) services in a wireless network, according to the embodiments as disclosed herein.

Referring to FIG. 2 illustrates DRX operation at UE when the network signals the XR specific start offset through XR specific DCP signalling and a common DRX configuration is used for legacy unicast services or non-XR services and XR services, according to the embodiments of the present disclosure;

At step 201, the method includes configuring, by a network apparatus, a XR wakeup signal at a user equipment (UE) and determining whether the XR wakeup signal are configured at the UE;

If the answer at step 201 is Yes, the method continues At step 202, the method includes determining, by a network apparatus, the active time considering grants/assignments/DRX Command MAC CE/Long DRX Command MAC CE received, Dynamic start offset received from DCP, Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-Response Window is running.

At step 203, the method includes determining, by the network apparatus, whether the XR WUS occasion in a time domain is associated with a DRX cycle and transmitting, by the network apparatus, a XR WUS indication to the UE;

If the answer at step 203 is No, the method continues At step 204, the method includes monitoring, by the UE, the XR WUS occasions outside of the determined DRX active time; Monitor XR WUS based on configuration. Is XR WUS indication received for this DRX cycle?

If the answer at step 204 is Yes, the method continues At step 205 is Yes, the method includes receiving, by the UE, the XR WUS indication received from the network apparatus based on the XR wakeup signal configured at the UE and determining, by the UE, whether the XR wakeup signal received with start offset from the network apparatus;

If the answer at step 205 is No, the method continues at step 206, the method includes activating, by the UE, the drx on duration timer after adding the drx-SlotOffset and the drx SlotOffsetXR from beginning of a subframe.

If the answer at step 204 is No, the method continues At step 207, the method includes determining whether the XR ps-Wakeup configured;

If the answer At step 207 is Yes, the method continues At step 208, the method includes start drx-onDurationTimer for this DRX group after drx-SlotOffset from the beginning of the subframe;

If the answer At step 208 is No, the method continues at step 209, the method includes Do not start drx-onDurationTimer for this DRX cycle;

If the answer at step 201 is No, the method continues at step 210, the method includes determining whether the Unicast DCP is configured.

If the answer at step 210 is No, the method continues at step 208, the method includes start drx-onDurationTimer for this DRX group after drx-SlotOffset from the beginning of the subframe;

If the answer at step 210 is Yes, the method continues at 211, the method includes following the unicast DCP operation.

If the answer at step 203 is Yes, the method continues at step 208, the method includes start drx-onDurationTimer for this DRX group after drx-SlotOffset from the beginning of the subframe;

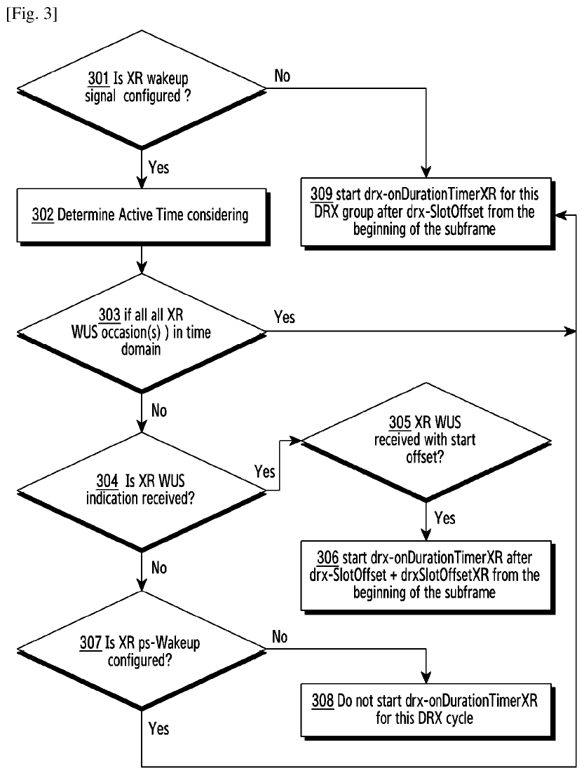

FIG. 3 is another example flow chart illustrating a method for handling of wake up signaling for Extended Reality (XR) services in a wireless network, according to the embodiments as disclosed herein.

Referring to FIG. 3 illustrates DRX operation at UE when the network signals the XR specific start offset through XR specific DCP signaling and separate DRX configuration is used for XR services, according to the embodiments of the present disclosure.

At step 301, the method includes configuring, by a network apparatus, a XR wakeup signal at a user equipment (UE) determining whether the XR wakeup signal are configured at the UE;

If the answer at step 301 is Yes, the method continues At step 302, the method includes determine active time considering grants/assignments/DRX Command MAC CE/Long DRX Command MAC CE received, Dynamic start offset received from DCP, Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-Response Window is running.

At step 303, the method includes determining, by the network apparatus, XR WUS occasion in a time domain is associated with a DRX cycle; if all XR WUS occasion(s) in time domain, associated with the current DRX cycle occurred in active time as determined.

If the answer at step 303 is No, the method At step 304, the method includes monitoring, by the UE, the XR WUS indication received for the DRX cycle from the network apparatus; Monitor XR WUS based on configuration. Is XR WUS indication received for this DRX cycle?

If the answer at step 304 is Yes, the method continues at step 305, the method includes determining whether the XR WUS received with the stat offset;

If the answer at step 305 is Yes, the method continues At step 306, the method includes activating, by the UE, the drx-on duration timerXR after adding the drx-SlotOffset from beginning of a subframe.

If the answer at step 304 is No, the method continues at step 307, determining whether the XR ps-Wakeup configured as TRUE.

If the answer at step 307 is No, the method continues at step 308, the method includes do not start drx-onDurationTimerXR for this DRX cycle.

If the answer At step 307 and 303 is Yes, the method continues at step 309, activating drx-onDurationTimerXR for this DRX group after drx-SlotOffset from the beginning of the subframe;

If the answer at step 301 is No, the method continues at step 309, the method includes activating drx-onDurationTimerXR for this DRX group after drx-SlotOffset from the beginning of the subframe;

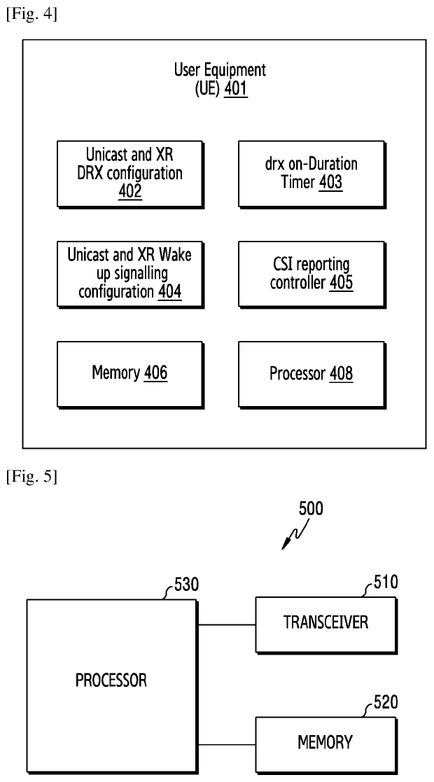

FIG. 4 illustrates hardware features of the UE for handling wake up signaling and CSI reporting for extended reality services in wireless networks, according to the embodiments of the present disclosure. The system includes memory, processor, Unicast and XR DRX configuration, drx on-Duration Timer, Unicast and XR wakeup signaling configuration, CSI reporting controllers coupled to the memory and processor for handling wake up signaling and CSI reporting for extended reality services as disclosed herein.

Although the FIG. 4 shows the hardware components of the system but it is to be understood that other embodiments are not limited thereon. In other embodiments, the system includes less or a greater number of components. Further, the labels or names of the components are used only for illustrative purpose and does not limit the scope of the disclosure. One or more components can be combined together to perform same or substantially similar technical feature for handling wake up signaling and CSI reporting for extended reality services. FIG. 4 includes a user equipment (401), a Unicast and XR DRX configuration (402), a drx on-Duration Timer (403), a Unicast and XR Wake up signaling configuration (404), a CSI reporting controller (405), a Memory (406) and a processor (408).

In an embodiment, the UE (401) is configured with DCP configuration and a flag dynamicStartOffset-XR indicating the DCP will carry dynamic start offset for XR services. The network apparatus transmits the drx-StartOffsetXR and/or drxSlotOffsetXR in the DCI carrying indication of wakeup signal and the UE (401) applies this offset value to delay or advance the starting of drx-onDurationTimer.

In an embodiment, the UE (401) for handling of wake up signaling for Extended Reality (XR) services in a wireless network. The UE (401) includes the unicast and XR DRX configuration (402), the drx on-Duration Timer (403), the Unicast and XR Wake up signaling configuration (404), a CSI reporting controller (405), communicatively coupled to the memory (406) and the processor (408), may configure an unicast DCP (DCI for power saving) and a XR wakeup signal at the user equipment (UE); determine the unicast DCP and the XR wakeup signal are configured at the UE (401); transmit one or more offset values to apply to the UE (401) for starting the DRX On duration Timer for XR services; adjust offset value to delay or to start in advance of a DRX On Duration Timer at the UE (401) for XR services in the wireless networks; and transmit a Channel State Information (CSI) by the User Equipment (UE) to the network apparatus.

In an embodiment, the UE (401) may configure the XR wakeup signal includes determine whether the XR wakeup signal is configured at the UE (401); determine whether XR WUS occasion in a time domain is associated with a DRX cycle; transmit a XR WUS indication to the UE (401); determine DRX active time of the UE (401) considering the one or more active time conditions; monitor the XR WUS occasions outside of the determined DRX active time; receive the XR WUS indication received from the network apparatus based on the XR wakeup signal configured at the UE (401); determine the XR wakeup signal received with start offset from the network apparatus; and activate the DRX On Duration Timer after adding the drx-SlotOffset and the drx SlotOffsetXR from beginning of a subframe.

In an embodiment, the UE (401) may configure configuring the XR wakeup signal includes configure a XR specific DRX configuration; determine the XR wakeup signal is configured at the UE (401); determine active time of the UE (401) considering the one or more active time conditions; determine XR WUS occasion in a time domain is associated with a DRX cycle occurred in the active time; transmit a XR WUS indication to the UE (401); monitor the XR WUS indication received from the network apparatus based on the XR wakeup signal configured at the UE (401); determine the XR wakeup signal received with start offset from the network apparatus; and activate a XR specific DRX On duration Timer, drx-onDurationTimerXR, after adding the drx-SlotOffset and the drx SlotOffsetXR from beginning of a subframe.

In an embodiment, the UE (401) configured to control the CSI reporting for extended reality services in wireless network transmission. The UE (401) may receive a allowCSI-SRS-Tx-XR-DRX-Active parameter in a RRC reconfiguration message from a network apparatus; determine the configured allowCSI-SRS-Tx-XR-DRX-Active parameter allows the UE (401) to transmit the SRS and report the CSI during a XR Discontinuous Reception (DRX);

In an embodiment, the UE (401) may be configured to determine time for transmitting the SRS and reporting the CSI during the XR service reception based on the allowCSI-SRS-Tx-XR-DRX-Active parameter when the allowCSI-SRS-Tx-XR-DRX-Active parameter; and transmit the SRS and report the CSI in the determined time based on an Active Time of the unicast DRX and the XR DRX.

In an embodiment, a DCI with CRC scrambled using PS-RNTI (DCP) monitoring is performed together for the legacy unicast (i.e. non-XR) and XR. This implies the DCP indication is common i.e. DCP indication received implies the legacy unicast (or non-XR) assignment and XR assignment, and causing the start of the drx-onDurationTimer, and no DCP indication received implies none of legacy unicast (or non-XR) assignment and XR assignment, and drx-onDurationTimer is not started. In an embodiment, if the UE (401) is configured to receive XR service and the UE (401) supports dynamic start offset for DRX, the common DCP indication carries the XR specific offset value and the indicator signaling whether the provided offset is positive or negative.

In an alternate embodiment, the UE (401) is configured by network with one or multiple offset values (e.g. in the RRC reconfiguration message) and the DCP indication carries the index of the configured value to be applied (e.g. in the DCI format 2_6 or any other DCI format 2_X). In another embodiment, the set of offset values are pre-defined and the network configures the UE (401) to associate one of the predefined sets with a particular XR service based on its traffic characteristics. The DCP indication then carries the index of the offset value to be used within that particular set.

In another embodiment, the DCP indication carries a bitmap wherein each ordered bit may represent the index of the offset values configured. Based on the bit in the bitmap which is set to 1, the UE (401) determines the index of the offset value configured and utilizes that offset value. In another embodiment, the DCP indication carries a bitmap where in each ordered bit represents a pre-determined offset value and based on bit that is set to 1, UE (401) determines the offset value, or accumulatively, all the bits of bitmap that are set to 1, together represent the offset value.

In an embodiment the network configures the UE (401) with the one of or combination of following parameters to reuse legacy DCP configurations for receiving XR specific dynamic drx-onDurationTimer start offset:

| | |
|---|---|
| DCP-ConfigXR-r18::= | SEQUENCE { |

| | |
|---|---|
| useDCPforXRoffset-r18 | ENUMERATED {true} |

OPTIONAL,
offsetValues SEQUENCE (SIZE (1..maxNoXrOffsetValues)) OF INTEGER{1..maxXrOffset}
OPTIONAL --conduseDCPforXRoffset
}

useDCPforXRoffset: Indicates if the UE (401) may use legacy DCP configurations for receiving XR specific drx-onDurationTimer start offset.

offsetValues: This list is configured by the network apparatus and indicates the list of offset values that may be indicated by the network to be applied. If the lists of values are configured, the legacy DCP carries the index of the offset value from the list to be applied. The DCP also indicates whether the offset is positive or negative in order to delay or advance the starting of drx-OnDurationTimer.

The DCP-ConfigXR IE may be configured as a common parameter or associated with one or more XR services specifically. Associating the configured offset values per service is beneficial as different services have different traffic characteristics and thus can have different Jitter values and frame rate dynamics.

| DCP-ConfigXR-r18::= | SEQUENCE { | |
|---|---|---|
| useDCPforXRoffset-r18 | ENUMERATED {true} | OPTIONAL, |

offsetValueList SEQUENCE (SIZE (1..maxNoXrServices)) OFoffsetValuesXr
OPTIONAL --conduseDCPforXRoffset
}

| | |
|---|---|
| offsetValuesXr::= | SEQUENCE { |
| xrServiceId | XRServiceId, |

offsetValues SEQUENCE (SIZE (1..maxNoXrOffsetValues)) OFINTEGER{1..maxXrOffset}
OPTIONAL
}

| | |
|---|---|
| XRServiceId | INTEGER (1..maxNoXrServices) |

In an embodiment, if the start offset values are configured per service, the legacy DCP carries the XR service ID along with the index of the offset value to be used. In an alternate embodiment, the network signals a common DRX start offset considering the maximum offset for all the XR services the UE is receiving. Alternatively, when the UE (401) receives indication to apply start offset via DCP, the UE applies the maximum of configured offset values if the UE (401) is receiving more than one XR service and more than one offset value is configured at the UE (401). When the DCP indication is received with the dynamic offset value or with an indication to apply the configured offset value the UE (401) computes the new start time for the drx-onDurationTimer.

In an embodiment, the network signals the DRX start offset to be applied or indication in the DL assignment DCI or a new DCI format. The DCI may also carry the indication for when to apply the offset value. In an embodiment, the UE (401) applies the offset value in the next DRX cycle or the DRX cycle specified in the indication.

In another embodiment, the UE (401) is configured to receive DCP indication before short DRX cycle. The network apparatus may configure the offset in time relative from start of the short DRX cycle for monitoring DCP associated with that short DRX cycle.

In another embodiment, the UE (401) is configured to receive DCP indication before long DRX cycle. The network apparatus may configure the offset in time relative from start of the long DRX cycle for monitoring DCP associated with that long DRX cycle

The following is a sample specification text indicating the changes involved due to introduction of above embodiment:

### Example

1> if the Short DRX cycle is used for a DRX group, and [(SFN×10)+subframe number] modulo (drx-ShortCycle)=(drx-StartOffset) modulo (drx-ShortCycle):
2> if UE is configured for XR service and UE is configured to receive dynamic slot offset for XR through DCP
3> if UE receives drx-SlotOffsetXR value from lower layer or indication to apply configured slot offset value from lower layer:
4> start drx-onDurationTimer after drx-SlotOffset+drx-SlotOffsetXR from the beginning of the subframe (where Subframe is determined by considering drxStartOffsetXR).
2> else:
> Start drx-onDurationTimer for this DRX group after drx-SlotOffset from the beginning of the subframe.
1> if the Long DRX cycle is used for a DRX group, and [(SFN×10)+subframe number] modulo (drx-LongCycle)=drx-StartOffset:
2> if DCP monitoring is configured for the active DL BWP as specified in TS 38.213 [6], clause 10.3:
3> if DCP is configured to carry XR specific offset:
4> if DCP associated with the current DRX cycle or a DL assignment DCI is received from lower layer with an indication to apply a offset value or an indication to apply a configured offset value for starting drx-OnDurationTimer:
5> start drx-onDurationTimer after drx-SlotOffset+drx-SlotOffsetXR from the beginning of the subframe (where Subframe is determined by considering drxStartOffsetXR).

NOTE: drx-SlotOffsetXR value may be positive or negative based on if the on duration should be delayed or advanced.
4> else:
5> if DCP indication associated with the current DRX cycle received from lower layer indicated to start drx-onDurationTimer, as specified in TS 38.213 [6]; or
5> if all DCP occasion(s) in time domain, as specified in TS 38.213 [6], associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-ResponseWindow is running (as specified in clause 5.1.4); or
5> if ps-Wakeup is configured with value true and DCP indication associated with the current DRX cycle has not been received from lower layers:
6> start drx-onDurationTimer after drx-SlotOffset from the beginning of the subframe.
3> else:
4> if DCP indication associated with the current DRX cycle received from lower layer indicated to start drx-onDurationTimer, as specified in TS 38.213 [6]; or
4> if all DCP occasion(s) in time domain, as specified in TS 38.213 [6], associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-ResponseWindow is running (as specified in clause 5.1.4); or
4> if ps-Wakeup is configured with value true and DCP indication associated with the current DRX cycle has not been received from lower layers:
5> start drx-onDurationTimer after drx-SlotOffset from the beginning of the subframe.
2> else:
3> start drx-onDurationTimer for this DRX group after drx-SlotOffset from the beginning of the subframe.

In an embodiment, the network apparatus configures the UE (401) with a XR specific wake up signal/DCP configuration through RRC signaling as part of RRC reconfiguration procedure. The WUS configuration may be one of common configuration for all XR services or service specific configuration. The XR specific WUS configuration includes at least one of or combination of the following parameters:
xr-psRNTI: XR specific power saving RNTI is used to scramble DCI carrying XR specific WUS and dynamic start offset,
xr-psPeriodicity: Indicates the periodicity of the XR specific Wake up signal. This is provided in multiples of DRX cycles. A value of 1 indicates every DRX cycle, 2 indicates that UE should monitor XR specific WUS every second DRX Cycle along with legacy DCP if configured.
Xr-OffsetValidityTimer: Indicates the number of DRX cycles the received offset value may be applied for. If configured with value ‘Infinity’, the UE uses the same offset value till a new value is signaled by the network.
xr-psOffset: The start of the search-time of DCI with CRC scrambled by XR-PS-RNTI relative to the start of the drx-onDurationTimer of Long DRX
size-xrWusDCI: Size of DCI carrying XR specific wake up signal
xr-psWakeup: Indicates if the UE wakes up if no XR WUS is received. If the field is not configured, the UE does not wake up if XR WUS is not received. The legacy ps-Wakeup field overrides this field behavior if configured.

In an embodiment, the UE (401) may indicate its preference for XR specific ps-offset value according to the jitter characteristics of the service the UE is accessing. The UE (401) indicates this preference using at least one of UE assistance information and NAS signaling.

The UE (401) monitors for the XR specific DCP/WUS along with legacy DCP monitoring if configured to do so. If xr-psPeriodicity is configured, the UE monitors for XR specific WUS only prior to the relevant DRX cycle occasions. The following is a sample specification text indicating the changes involved due to introduction of above embodiment:

### Example

1> if the Short DRX cycle is used for a DRX group, and [(SFN×10)+subframe number] modulo (drx-ShortCycle)=(drx-StartOffset) modulo (drx-ShortCycle):
2> if the previously received offset value is valid (based on xr-ValidityTimer value) for the current DRX cycle or;
2> if UE is configured for XR service and UE is configured to receive dynamic slot offset through XR specific Wake up signal
3> if UE receives drx-SlotOffsetXR value from lower layer or indication to apply configured slot offset value from lower layer:
4> start drx-onDurationTimer after drx-SlotOffset+drx-SlotOffsetXR from the beginning of the subframe (where Subframe is determined by considering drxStartOffsetXR).
2> else:
3> Start drx-onDurationTimer for this DRX group after drx-SlotOffset from the beginning of the subframe.
1> if the Long DRX cycle is used for a DRX group, and [(SFN×10)+subframe number] modulo (drx-LongCycle)=drx-StartOffset:
2> if DCP monitoring is configured for the active DL BWP as specified in TS 38.213 [6], clause 10.3; or XR specific Wake up signal monitoring is configured:
3> if DCP indication associated with the current DRX cycle received from lower layer indicated to start drx-onDurationTimer, as specified in TS 38.213 [6]; or
3> if all DCP occasion(s) in time domain, as specified in TS 38.213 [6], associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-ResponseWindow is running (as specified in clause 5.1.4); or
3> if ps-Wakeup is configured with value true and DCP indication associated with the current DRX cycle has not been received from lower layers:
4> start drx-onDurationTimer for this DRX group after drx-SlotOffset from the beginning of the subframe.
3> if XR specific WUS indication associated with current DRX cycle is received from lower layers and,
3> if UE receives drx-SlotOffsetXR value from lower layer or indication to apply configured slot offset value from lower layer or if the previously received offset value is valid (based on xr-ValidityTimer value) for the current DRX cycle;
4> start drx-onDurationTimer after drx-SlotOffset+drx-SlotOffsetXR from the beginning of the subframe (where Subframe is determined by considering drxStartOffsetXR).
3> else:
4> if xr-psWakeup is configured and legacy DCP is not configured:
5> start drx-onDurationTimer for this DRX group after drx-SlotOffset from the beginning of the subframe.
2> else:
3> start drx-onDurationTimer for this DRX group after drx-SlotOffset from the beginning of the subframe.

In an embodiment, the UE (401) is configured with a separate DRX configuration for XR services. The XR specific DRX configuration may be a common configuration for all XR services the UE is receiving or may be mapped to one or more XR services separately. The network provides the XR specific wake up signaling configuration which are used to indicate the start of active DRX time for the associated XR DRX configuration. The wake up signal indication may be a common signal which provides the dynamic start offset for any of the XR DRX cycles. The WUS monitoring may also be configured per XR service and its corresponding DRX configuration.

The following is a sample specification text indicating the changes involved due to introduction of above embodiment:

### Example

<Text from Section: 5.7x: XR Specific DRX Handling from 38.321>
1> if the Long DRX cycle is used for this XR DRX configuration, and [(SFN×10)+subframe number] modulo (drx-LongCycleXR)=drx-StartOffset:
2> if XR specific Wake up signal monitoring is configured:
3> if XR specific WUS indication associated with current DRX cycle and XR service is received from lower layers without any offset value or,
3> if all XR WUS occasion(s) in time domain associated with the current XR DRX cycle occurred in Active Time considering grants/assignments/DRX Command MAC CE/Long DRX Command MAC CE received and Scheduling Request sent until 4 ms prior to start of the last XR WUS occasion, or during a measurement gap, or when the MAC entity monitors for a PDCCH transmission on the search space indicated by recoverySearchSpaceId of the SpCell identified by the C-RNTI while the ra-Response Window is running (as specified in clause 5.1.4); or
3> if xr-psWakeup is configured with value true and XR WUS indication associated with the current DRX cycle has not been received from lower layers:
4> start drx-onDurationTimerXR for this DRX configuration after drx-SlotOffset from the beginning of the subframe.
3> else If the previously received offset value is valid (based on xr-ValidityTimer value) for the current DRX cycle or;
3> if UE receives drx-SlotOffsetXR value from lower layer or indication to apply configured slot offset value from lower layer:
4> start drx-onDurationTimer after drx-SlotOffset+drx-SlotOffsetXR from the beginning of the subframe (where Subframe is determined by considering drxStartOffsetXR).

NOTE: drx-SlotOffsetXR value may be positive or negative based on if the on duration should be delayed or advanced.
3> else:
4> if xr-psWakeup is configured and legacy DCP is not configured:
5> start drx-onDurationTimer for this DRX group after drx-SlotOffset from the beginning of the subframe.
2> else:
3> start drx-onDurationTimerXR for this XR DRX configuration after drx-SlotOffset from the beginning of the subframe

In an alternate embodiment, the legacy DCP indication carries the offset value for XR specific DRX onDurationTimer start. The legacy DCP configuration is applied for the common XR DRX configuration or all XR service specific DRX configurations. A flag in the XR DRX configuration indicates if legacy DCP configuration is applied to XR DRX.

In an embodiment, the wake up signal indication carries at least one of or combination of the following:
Indication to apply a pre-configured start offset value
Indication if the offset is positive or negative which implies if the drx-onDurationTimer start should be delayed or advanced,
Index or bitmap indicating which offset value to apply from the set of configured values
Index or bitmap indicating the service or group of services the wake up signal applies to. This could also indicate for which DRX configuration the WUS is applied for.
Indication if the offset in WUS is to be applied for more than one DRX cycle

In an embodiment, Active Time of the common DRX (i.e. for legacy unicast or non-XR and XR) of the MAC entity is determined to consider whether CSI and/or SRS transmission is performed or not. The Active Time is determined with considering drxStartOffsetXR and/or drx-SlotOffsetXR received through legacy DCP or XR specific WUS.

In an embodiment, in case of a common DRX group used for unicast and XR service reception, if CSI-masking is setup for legacy unicast (or non-XR) and/or XR and if in current symbol n, if drx-onDurationTimer of a DRX group would not be running considering grants/assignments scheduled on Serving Cell(s) in this DRX group and DRX Command MAC CE/Long DRX Command MAC CE and drx-StartOffsetXR and/or drx-SlotOffsetXR received until 4 ms prior to symbol n when evaluating all DRX Active Time conditions, MAC entity does not report CSI on PUCCH in this DRX group.

In an embodiment, CSI-masking is not applied when the UE (401) is configured with XR service, and common DRX configuration for the unicast/non-XR and XR is configured/utilized, as the drx-onDurationTimer operation is differently affected for different UEs and network cannot be benefitted with the coordinated PUCCH resource saving and/or efficient utilization.

The following is a sample specification text indicating the changes involved due to introduction of above embodiment:

### Example

1> if DCP monitoring is configured for the active DL BWP as specified in TS 38.213 [6], clause 10.3 or XR specific WUS is configured; and
1> if the current symbol n occurs within drx-onDurationTimer duration; and
1> if drx-onDurationTimer associated with the current DRX cycle is not started as specified in this clause:
2> if the MAC entity would not be in Active Time considering grants/assignments/DRX Command MAC CE/Long DRX Command MAC CE and drxStartOffsetXR and/or drx-SlotOffsetXR received through legacy DCP or XR specific WUS and Scheduling Request sent until 4 ms prior to symbol n when evaluating all DRX Active Time conditions as specified in this clause; and
2> if allowCSI-SRS-Tx-MulticastDRX-Active is not configured or, if all multicast DRXes would not be in Active Time considering multicast assignments and DRX Command MAC CE for MBS multicast received until 4 ms prior to symbol n when evaluating all DRX Active Time conditions as specified in Clause 5.7b and all multicast sessions are configured with multicast DRX:
3> not transmit periodic SRS and semi-persistent SRS defined in TS 38.214 [7];
3> not report semi-persistent CSI configured on PUSCH;
3> if ps-TransmitPeriodicL1-RSRP is not configured with value true:
4> not report periodic CSI that is L1-RSRP on PUCCH.
3> if ps-TransmitOtherPeriodicCSI is not configured with value true:
4> not report periodic CSI that is not L1-RSRP on PUCCH.
1> else:
2> in current symbol n, if a DRX group would not be in Active Time considering grants/assignments scheduled on Serving Cell(s) in this DRX group and DRX Command MAC CE/Long DRX Command MAC CE and drx-StartOffsetXR and/or drx-SlotOffsetXR received and Scheduling Request sent until 4 ms prior to symbol n when evaluating all DRX Active Time conditions as specified in this clause; and
2> if allowCSI-SRS-Tx-MulticastDRX-Active is not configured or, in current symbol n, if all multicast DRXes corresponding to the DRX group would not be in Active Time considering multicast assignments and DRX Command MAC CE for MBS multicast received until 4 ms prior to symbol n when evaluating all DRX Active Time conditions as specified in Clause 5.7b and all multicast sessions corresponding to the DRX group are configured with multicast DRX:
3> not transmit periodic SRS and semi-persistent SRS defined in TS 38.214 [7] in this DRX group;
3> not report CSI on PUCCH and semi-persistent CSI configured on PUSCH in this DRX group.
2> if CSI masking (csi-Mask) is setup by upper layers:
3> in current symbol n, if drx-onDurationTimer of a DRX group would not be running considering grants/assignments scheduled on Serving Cell(s) in this DRX group and DRX Command MAC CE/Long DRX Command MAC CE and drxStartOffsetXR and/or drx-SlotOffsetXR received until 4 ms prior to symbol n when evaluating all DRX Active Time conditions as specified in this clause; and
3> if allowCSI-SRS-Tx-MulticastDRX-Active is not configured or, in current symbol n, if drx-onDurationTimerPTM(s) of all multicast DRXes corresponding to the DRX group would not be running considering multicast assignments and DRX Command MAC CE for MBS multicast received until 4 ms prior to symbol n when evaluating all DRX Active Time conditions as specified in Clause 5.7b and all multicast sessions corresponding to the DRX group are configured with multicast DRX:
4> not report CSI on PUCCH in this DRX group.

NOTE 4: If a UE multiplexes a CSI configured on PUCCH with other overlapping UCI(s) according to the procedure specified in TS 38.213 [6] clause 9.2.5 and this CSI multiplexed with other UCI(s) would be reported on a PUCCH resource either outside DRX Active Time of the DRX group in which this PUCCH is configured or outside the on-duration period of the DRX group in which this PUCCH is configured if CSI masking is setup by upper layers, it is up to UE implementation whether to report this CSI multiplexed with other UCI(s).

Regardless of whether the MAC entity is monitoring PDCCH or not on the Serving Cells in a DRX group, the MAC entity transmits HARQ feedback, aperiodic CSI on PUSCH, and aperiodic SRS defined in TS 38.214 [7] on the Serving Cells in the DRX group when such is expected. The MAC entity need not monitor the PDCCH if it is not a complete PDCCH occasion (e.g. the Active Time starts or ends in the middle of a PDCCH occasion).

In an embodiment, in case of a separate DRX configurations for XR specific services reception, if CSI-masking, masking for transmission of SRS, periodic L1 reporting prohibition is setup for XR and if in current symbol n, if drx-onDurationTimer-XR of XR DRX group would not be running considering delaying of start due to reception of drx-SlotOffsetXR via unicast DCP and/or XR specific WUS, grants/assignments scheduled on Serving Cell(s) in this DRX group and DRX Command MAC CE/Long DRX Command MAC CE and scheduling request sent until 4 ms prior to symbol n when evaluating all DRX Active Time conditions, MAC entity does not report CSI on PUCCH in this DRX group.

In an embodiment, the UE (401) is configured to allow transmission of semipersistent CSI reports, periodic SRS and semi-persistent SRS when the UE is not in DRX Active period.

The network signals this indication to the UE (401) as part of RRC configuration provided via RRCReconfiguration message. The configuration may be a common configuration for all XR specific DRXes or provided per XR DRX configuration.

allowCSI-SRS-Tx-XR-DRX-Active: This flag is used to control the CSI/SRS transmission during XR DRX ActiveTime.

In an embodiment, the following XR specific masking parameters are configured by the network apparatus to indicate if the UE is allowed to transmit, periodic L1-RSRP and non-L1-RSPR reporting when the current symbol is not in XR DRX active time. In an embodiment, the configuration parameter can be a common configuration for all XR services in common or may be configured per service or a group of services. In an alternate embodiment, the existing parameters (ps-TransmitPeriodicL1-RSRP, xr-ps-TransmitOtherPeriodicCSI, xr-csi-Mask) may be extended to apply for XR DRXs as well.

New parameters introduced are as follows
xr-ps-TransmitPeriodicL1-RSRP: Indicates the UE to transmit periodic L1-RSRP report(s) when the drx-onDurationTimerXR does not start. If the field is absent, the UE does not transmit periodic L1-RSRP report(s) when the drx-onDurationTimerXR does not start.
xr-ps-TransmitOtherPeriodicCSI: Indicates the UE to transmit periodic CSI report(s) other than L1-RSRP reports when the drx-onDurationTimerXR does not start. If the field is absent, the UE does not transmit periodic CSI report(s) other than L1-RSRP reports when the drx-onDurationTimerXR does not start.
xr-csi-Mask: If this flag is configured to true, the UE limits transmission of CSI reporting to on duration period of the XR specific DRX cycles.

Extending existing parameters are as follows—
ps-TransmitPeriodicL1-RSRP: Indicates the UE to transmit periodic L1-RSRP report(s) when the drx-onDurationTimer does not start. If the field is absent, the UE does not transmit periodic L1-RSRP report(s) when the drx-onDurationTimer does not start. If XR services are associated with XR specific DRX configurations, this field indicates UE to transmit UE
ps-TransmitOtherPeriodicCSI: Indicates the UE to transmit periodic CSI report(s) other than L1-RSRP reports when the drx-onDurationTimerXR does not start. If the field is absent, the UE does not transmit periodic CSI report(s) other than L1-RSRP reports when the drx-onDurationTimerXR does not start.
csi-Mask: If this flag is configured to true, the UE limits transmission of CSI reporting to on duration period of the XR specific DRX cycles.

The following is a sample specification text indicating the changes involved due to introduction of above embodiment:

### Example

1> if DCP monitoring is configured for the active DL BWP as specified in TS 38.213 [6], clause 10.3; or XR WUS monitoring is configure for active DL BWP; and
1> if the current symbol n occurs within drx-onDurationTimer duration; and
1> if drx-onDurationTimer associated with the current DRX cycle is not started as specified in this clause:
2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause; and
2> if allowCSI-SRS-Tx-MulticastDRX-Active is not configured or, if all multicast DRXes would not be in Active Time considering multicast assignments and DRX Command MAC CE for MBS multicast received until 4 ms prior to symbol n when evaluating all DRX Active Time conditions as specified in Clause 5.7b and all multicast sessions are configured with multicast DRX:
2> if allowCSI-SRS-Tx-XrDRX-Active is not configured or, in current symbol n, if all XR DRXs would not be in active time considering XR assignment and DRX Command MAC CR for XR and drx-StartOffsetXR and/or drx-SlotOffsetXR received until 4 ms prior to symbol n when evaluating all DRX active time conditions and all XR sessions are configured with XR DRX:
3> not transmit periodic SRS and semi-persistent SRS defined in TS 38.214 [7];
3> not report semi-persistent CSI configured on PUSCH;
3> if ps-TransmitPeriodicL1-RSRP is not configured with value true:
4> not report periodic CSI that is L1-RSRP on PUCCH.
3> if ps-TransmitOtherPeriodicCSI is not configured with value true:
4> not report periodic CSI that is not L1-RSRP on PUCCH.
1> else:
2> in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause; and
2> if allowCSI-SRS-Tx-MulticastDRX-Active is not configured or, in current symbol n, if all multicast DRXes corresponding to the DRX group would not be in Active Time considering multicast assignments and DRX Command MAC CE for MBS multicast received until 4 ms prior to symbol n when evaluating all DRX Active Time conditions as specified in Clause 5.7b and all multicast sessions corresponding to the DRX group are configured with multicast DRX:
2> if allowCSI-SRS-Tx-XrDRX-Active is not configured or, in current symbol n, if all XR DRXs would not be in active time considering XR assignment and DRX Command MAC CR for XR and drx-StartOffsetXR and/or drx-SlotOffsetXR received until 4 ms prior to symbol n when evaluating all DRX active time conditions and all XR sessions are configured with XR DRX:
3> not transmit periodic SRS and semi-persistent SRS defined in TS 38.214 [7] in this DRX group;
3> not report CSI on PUCCH and semi-persistent CSI configured on PUSCH in this DRX group.
2> if CSI masking (csi-Mask) is setup by upper layers:
3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause; and
3> if allowCSI-SRS-Tx-MulticastDRX-Active is not configured or, in current symbol n, if drx-onDurationTimerPTM(s) of all multicast DRXes corresponding to the DRX group would not be running considering multicast assignments and DRX Command MAC CE for MBS multicast received until 4 ms prior to symbol n when evaluating all DRX Active Time conditions as specified in Clause 5.7b and all multicast sessions corresponding to the DRX group are configured with multicast DRX:
3> if allowCSI-SRS-Tx-XrDRX-Active is not configured or, in current symbol n, if drx-onDurationTimerXR(s) of all XR DRXes corresponding to the DRX group would not be running considering XR assignments and DRX Command MAC CE for XR services and drx-StartOffsetXR and/or drx-SlotOffsetXR received until 4 ms prior to symbol n when evaluating all DRX Active Time conditions and all XR sessions corresponding to the DRX group are configured with XR DRX:
4> not report CSI on PUCCH in this DRX group.

FIG. 5 illustrates a structure of a UE according to an embodiment of the disclosure.

As shown in FIG. 5, the UE according to an embodiment may include a transceiver 510, a memory 520, and a processor 530. The transceiver 510, the memory 520, and the processor 530 of the UE may operate according to a communication method of the UE described above. However, the components of the UE are not limited thereto. For example, the UE may include more or fewer components than those described above. In addition, the processor 530, the transceiver 510, and the memory 520 may be implemented as a single chip. Also, the processor 530 may include at least one processor. The UE of FIG. 5 corresponds to the UE in embodiments of other Figures described above.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for upconverting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE. Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 may receive a data signal including a control signal transmitted by the base station or the network entity, and the processor 530 may determine a result of receiving the control signal and the data signal transmitted by the base station or the network entity.

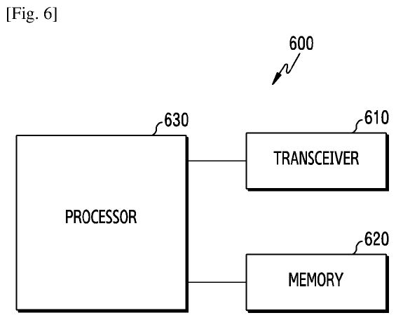

FIG. 6 illustrates a structure of a network entity (or network apparatus) according to an embodiment of the disclosure.

Referring to FIG. 6, the network entity (or network apparatus) includes a transceiver (610), a memory (620), and a processor (630). The transceiver (610), the memory (620), and the processor (630) of the network entity may operate according to a communication method of the network entity described above. However, the components of the terminal are not limited thereto. For example, the network entity may include fewer or a greater number of components than those described above. However, the components of the network entity are not limited thereto. For example, the network entity may include more or fewer components than those described above. In addition, the processor (630), the transceiver (610), and the memory (620) may be implemented as a single chip. Also, the processor (630) may include at least one processor.

The network entity includes a base station. Further, The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver (610) collectively refers to a network entity receiver and a network entity transmitter, and may transmit/receive a signal to/from a base station or a UE. The signal transmitted or received to or from the base station or the UE may include control information and data. In this regard, the transceiver (610) may include an RF transmitter for up-converting and amplifying a frequency of a transmitted signal, and an RF receiver for amplifying low-noise and down-converting a frequency of a received signal. However, this is only an example of the transceiver (610) and components of the transceiver (610) are not limited to the RF transmitter and the RF receiver.

The transceiver (610) may receive and output, to the processor (630), a signal through a wireless channel, and transmit a signal output from the processor (630) through the wireless channel.

The memory (620) may store a program and data required for operations of the network entity. Also, the memory (620) may store control information or data included in a signal obtained by the network entity. The memory (620) may be a storage medium, such as a ROM, a RAM, a hard disk, a CD-ROM, and a DVD, or a combination of storage media.

The processor (630) may control a series of processes such that the network entity operates as described above. For example, the transceiver (610) may receive a data signal including a control signal, and the processor (630) may determine a result of receiving the data signal.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Those skilled in the art will understand that the various illustrative logical blocks, modules, circuits, and steps described in this disclosure may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this disclosure.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this disclosure may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1-15. (canceled)

16. A method performed by a user equipment (UE) in a wireless communication system, the method comprising:
receiving, from a base station (BS), a message including first information on an offset related to a wakeup signal (WUS) and second information on a periodicity related to the WUS; and
monitoring the WUS before a start of a discontinuous reception (DRX) on duration timer based on the first information and the second information.

17. The method of claim 16, further comprising:
in case that the UE receives the WUS, starting the DRX on duration timer based on the WUS.

18. The method of claim 16, wherein at least one of periodic channel state information (CSI) or L1 reference signal received power (RSRP) is not reported to the BS during the DRX on duration timer.

19. The method of claim 16, wherein the message includes a radio resource control (RRC) reconfiguration message.

20. The method of claim 16, wherein the first information and the second information are associated with an RRC connected state of the UE.

21. A method performed by a base station in a wireless communication system, the method comprising:
transmitting, to a user equipment (UE), a message including first information on an offset related to a wakeup signal (WUS) and second information on a periodicity related to the WUS; and
transmitting, to the UE, the WUS before a start of a discontinuous reception (DRX) on duration timer based on the first information and the second information.

22. The method of claim 21, wherein the DRX on duration timer is started based on the WUS.

23. The method of claim 21, wherein at least one of periodic channel state information (CSI) or L1 reference signal received power (RSRP) is not reported during the DRX on duration timer.

24. The method of claim 21, wherein the message includes a radio resource control (RRC) reconfiguration message.

25. The method of claim 21, wherein the first information and the second information are associated with an RRC connected state of the UE.

26. A user equipment (UE) in a wireless communication system, the UE comprising:
a transceiver; and
a controller coupled with the transceiver and configured to:
receive, from a base station (BS), a message including first information on an offset related to a wakeup signal (WUS) and second information on a periodicity related to the WUS; and
monitor the WUS before a start of a discontinuous reception (DRX) on duration timer based on the first information and the second information.

27. The UE of claim 26, wherein the controller is further configured to:
in case that the UE receives the WUS, start the DRX on duration timer at the offset based on the WUS.

28. The UE of claim 26, wherein at least one of periodic channel state information (CSI) or L1 reference signal received power (RSRP) is not reported to the BS during the DRX on duration timer.

29. The UE of claim 26, wherein the message includes a radio resource control (RRC) reconfiguration message.

30. The UE of claim 26, wherein the first information and the second information are associated with an RRC connected state of the UE.

31. A base station (BS) in a wireless communication system, the BS comprising:
a transceiver; and
a controller coupled with the transceiver and configured to:
transmit, to a user equipment (UE), a message including first information on an offset related to a wakeup signal (WUS) and second information on a periodicity related to the WUS; and
transmit, to the UE, the WUS before a start of a discontinuous reception (DRX) on duration timer based on the first information and the second information.

32. The BS of claim 31, wherein the DRX on duration timer is started based on the WUS.

33. The BS of claim 31, wherein at least one of periodic channel state information (CSI) or L1 reference signal received power (RSRP) is not reported during the DRX on duration timer.

34. The BS of claim 31, wherein the message includes a radio resource control (RRC) reconfiguration message.

35. The BS of claim 31, wherein the first information and the second information are associated with an RRC connected state of the UE.
